(19) United States
(12) Patent Application Publication
(10) Pub. No.: US 2026/0229423 A1
(43) Pub. Date: Aug. 6, 2026

(54) KEYSWITCH STRUCTURE

(71) Applicant: DARFON ELECTRONICS CORP., Taoyuan City (TW)

(72) Inventors: Po-Wei Tsai, Taoyuan City (TW); Hsiao-Han Chu, Taoyuan City (TW)

(73) Assignee: DARFON ELECTRONICS CORP., Taoyuan City (TW)

(21) Appl. No.: 19/454,309

(22) Filed: Jan. 20, 2026

Related U.S. Application Data
(60) Provisional application No. 63/753,402, filed on Feb. 3, 2025.

(30) Foreign Application Priority Data
Jan. 12, 2026 (TW) 115101030

(51) Int. Cl. H01H 13/14; H01H 13/10

(52) U.S. Cl. CPC H01H 13/14; H01H 13/10

(57) ABSTRACT

A key switch structure includes a base plate, a keycap above the base plate, and two supports connected to the base plate and the keycap. The base plate has an opening, a base hook extending from a side of the opening, and a tab extending from another side of the opening along an extending direction. The two supports are pivotally connected around a pivot axis that is not parallel to the extending direction. The keycap moves along a vertical direction relative to the base plate between a pressed position and an unpressed position through the two supports. The vertical direction is perpendicular to the pivot axis and the extending direction. One of the supports includes a base plate connecting end portion located above the tab and rotatably connected to the base hook. When the keycap is in the pressed position, the base plate connecting end portion abuts against the tab.

### CROSS REFERENCE TO RELATED APPLICATIONS

This application claims the benefit of U.S. Provisional Application No. 63/753,402, filed on February 3rd, 2025. The content of the application is incorporated herein by reference.

### BACKGROUND OF THE INVENTION

### Field of the Invention

The present invention relates to a keyboard, and more particularly to a key switch structure for a keyboard.

### DESCRIPTION OF THE RELATED ART

As key switch structures become thinner, the space available for each component is greatly reduced, making it difficult to maintain the structural strength of the components and thus reducing the stability of all movements in the key switch structure. For example, the base plate of the key switch structure typically has multiple openings in order to form structures (e.g., hooks) that connect to the supports of the key switch structure and to avoid interference with the supports (e.g., when the keycap of the key switch structure is pressed down, part of the supports moves downward, which could cause structural interference with the base plate). The portion of the base plate end of the support (connected to the base plate) corresponding to the opening is difficult to be supported by the base plate in the vertical direction, which easily makes the keycap loose in the vertical direction. The looseness is usually reduced by adding a preload of the keycap on the rubber dome of the key switch structure so that the keycap is always pushed upward by the rubber dome. However, if the rubber dome is pre-compressed too much, it is easy for the rubber dome to become tilted, which makes the force storage/release process of the rubber protrusions unstable during the pressing/releasing of the keycap.

### SUMMARY OF THE INVENTION

In view of the problems in the prior art, an objective of the invention is to provide a key switch structure, in which a base plate has a tab for a base plate connecting end portion of a support to abut against, thereby increasing support of the base plate for the support and reducing the looseness of the keycap in the vertical direction.

A key switch structure of an embodiment according to the invention includes a base plate, a keycap, a first support, and a second support. The base plate has an opening, a base hook extending from a first side of the opening, and a tab extending from a second side of the opening along an extending direction. The keycap is disposed above the base plate. The first support is connected to the base plate and the keycap. The first support includes a base plate connecting end portion. The base plate connecting end portion is located above the tab and is rotatably connected to the base hook. The second support is connected to the base plate and the keycap. The first support and the second support are pivotally connected around a pivot axis. The pivot axis is not parallel to the extending direction. The keycap moves relative to the base plate along a vertical direction between a pressed position and an unpressed position through the first support and the second support. The vertical direction is perpendicular to the pivot axis and the extending direction. Therein, when the keycap is in the pressed position, the base plate connecting end portion abuts against the tab. Thereby, the base plate increases support for (the base plate connecting end portion of) the first support through the tab, thereby reducing the looseness of the keycap in the vertical direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a key switch structure according to a first embodiment.

FIG. 2 is a partially-exploded view of the key switch structure in FIG. 1.

FIG. 3 is an exploded view of the key switch structure in FIG. 1.

FIG. 4 is a top view of a base plate, a first support, and a second support of the key switch structure in FIG. 2, in which the outline of a keycap of the key switch structure relative to the base plate is shown in chain lines.

FIG. 5 is a top view of the base plate of the key switch structure in FIG. 2, in which the outlines of the first support and the second support relative to the base plate are shown in dashed lines and the outline of the keycap is shown in chain lines.

FIG. 6 is a sectional view of the key switch structure in FIG. 1 along the line X-X.

FIG. 7 is a sectional view of the key switch structure in FIG. 6 when the keycap is pressed.

FIG. 8 is a partially-exploded view of a key switch structure according to a second embodiment.

FIG. 9 is an exploded view of the left side of the key switch structure in FIG. 8.

FIG. 10 is a top view of a base plate, a first support, and a second support of the keys witch structure in FIG. 8, in which the outline of a keycap of the key switch structure relative to the base plate is shown in chain lines.

FIG. 11 is a top view of the base plate of the key switch structure in FIG. 8, in which the outlines of the first support and the second support relative to the base plate are shown in dashed lines and the outline of the keycap relative to the base plate is shown in chain lines.

FIG. 12 is a sectional view of the key switch structure, in which the cutting position is shown by the line Y-Y in FIG. 8.

FIG. 13 is a sectional view of the key switch structure in FIG. 12 when the keycap is pressed.

### DETAILED DESCRIPTION

Directional terms mentioned in the following embodiments, such as up, down, left, right, front or back, etc., are only for reference to the directions in the attached drawings. The prefixes of component names, such as first, second, ..., etc., are only used to distinguish components and facilitate description, and do not impose other restrictions on the components themselves; furthermore, components with the same prefix in various embodiments do not necessarily correspond. The correspondence of components in each embodiment should still depend on the specific structure described in each embodiment.

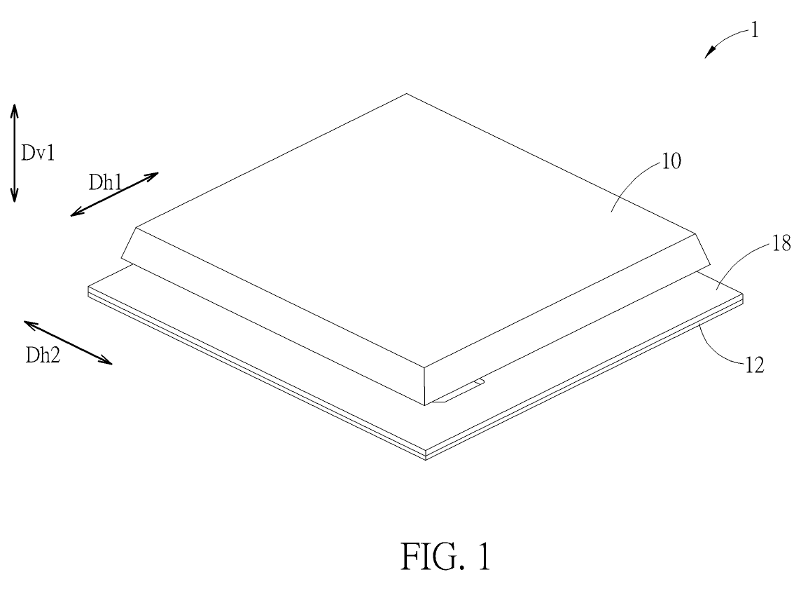

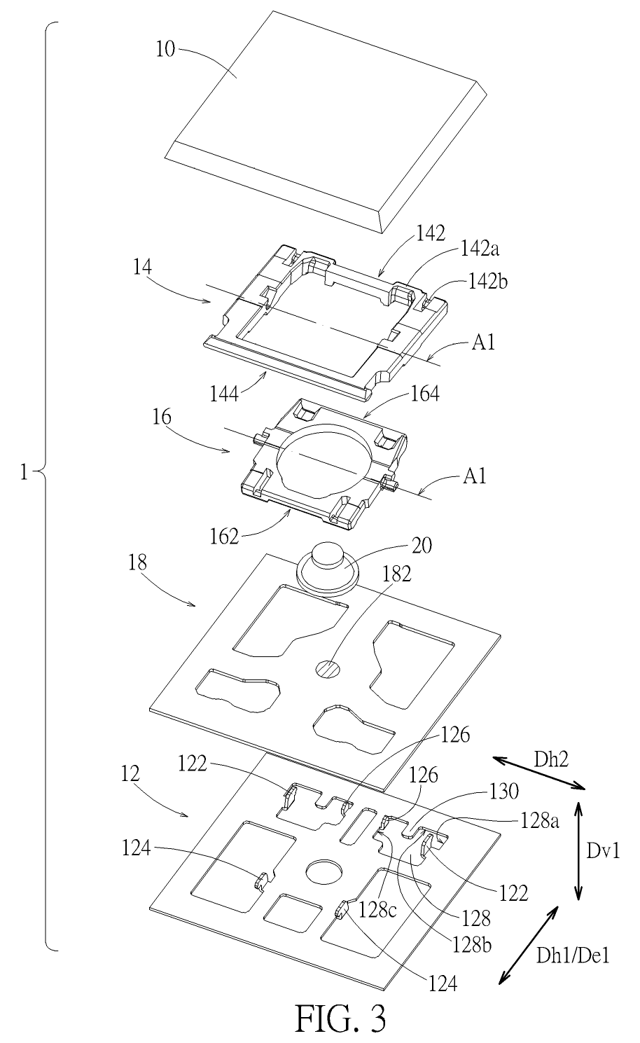

Please refer to FIG. 1 to FIG. 3. A key switch structure 1 according to a first embodiment is a square key, such as, but not limited to, letter keys and number keys on a keyboard. The key switch structure 1 includes a keycap 10, a base plate 12, a first support 14, a second support 16, a switch circuit board 18, and an elastic dome 20. The keycap 10 is disposed above the base plate 12. The first support 14 and the second support 16 are pivotally connected around a pivot axis A1 (indicated by a chain line in the figures). The first support 14 and the second support 16 are both connected to and located between the base plate 12 and the keycap 10 to support the keycap 10 above the base plate 12, so that the keycap 10 can move up and down relative to the base plate 12 along a vertical direction Dv1 (indicated by a double-headed arrow in the figures) through the first support 14 and the second support 16. The vertical direction Dv1 is perpendicular to the pivot axis A1. The switch circuit board 18 is stacked on the base plate 12. The switch circuit board 18 is shown by a single board in the figures to simplify the drawing. The switch circuit board 18 may be, but is not limited to, a membrane circuit board having a switch 182 (indicated by a circle filled with oblique lines in FIG. 3), which roughly corresponds to the center of the keycap 10. The elastic dome 20 is aligned with the switch 182 and disposed on the switch circuit board 18 under the keycap 10.

For more details, in the first embodiment, both the first support 14 and the second support 16 are rectangular frame supports. The second support 16 is pivotally connected to the inner side of the first support 14. The first support 14 includes a base plate connecting end portion 142 and a keycap connecting end portion 144. The first support 14 is rotatably connected to base hooks 122 of the base plate 12 that the base plate connecting end portion 142, and is rotatably and slidably connected to the keycap 10 through the keycap connecting end portion 144. The second support 16 includes a base plate connecting end portion 162 and a keycap connecting end portion 164. The second support 16 is rotatably and slidably connected to base hooks 124 of the base plate 12 through the base plate connecting end portion 162, and is rotatably connected to the keycap 10 through the keycap connecting end portion 164.

Furthermore, the base plate 12 includes two stop portions 126, which are configured to prevent the base plate connecting end portion 142 from detaching from the base hook 122; therein, the base hooks 122 and the stop portions 126 are located on opposite sides of the base plate connecting end portion 142 in a direction perpendicular to the pivot axis A1 (i.e., a horizontal direction Dh1, indicated by a double-headed arrow in the figures). The base plate 12 is structurally symmetrical with respect to the horizontal direction Dh1. Corresponding to one base hook 122 and one stop portion 126, the base plate 12 has an opening 128, and the base hook 122 and the stop portion 126 bend and extend from different sides of the opening 128 (i.e., a first side 128a and a third side 128c, respectively). The first side 128a and the third side 128c are opposite each other in a direction parallel to the pivot axis A1 (i.e., another horizontal direction Dh2, indicated by a double arrow in the figures). A portion 142a of the base plate connecting end portion 142 of the first support 14, located above the opening 128, is in principle not supported by the base plate 12.

However, in the first embodiment, corresponding to the opening 128, the base plate 12 includes a tab 130 that extends from a second side 128b of the opening 128 along an extending direction De1 (equivalent to the horizontal direction Dh1 and indicated by a double-headed arrow in the figures). The second side 128b is located between the first side 128a and the third side 128c in the horizontal direction Dh2. The tab 130 is located between the base hook 122 and the stop portion 126 in the horizontal direction Dh2, and also between the base hook 122 and the center of keycap 10 in the horizontal direction Dh2. The portion 142a of the base plate connecting end portion 142 is located above the tab 130 (i.e., the tab 130 is located below this portion 142a, so that the tab 130 can provide support for this portion 142a). Furthermore, the extending direction De1 is not parallel to the pivot axis A1; in the first embodiment, the extending direction De1 is parallel to the horizontal direction Dh1 and perpendicular to the vertical direction Dv1.

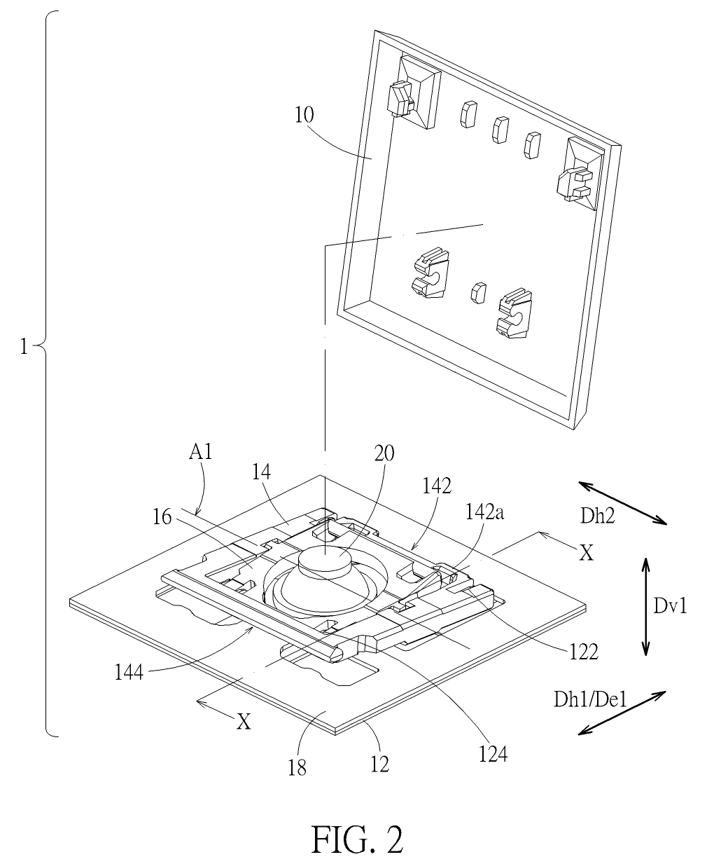

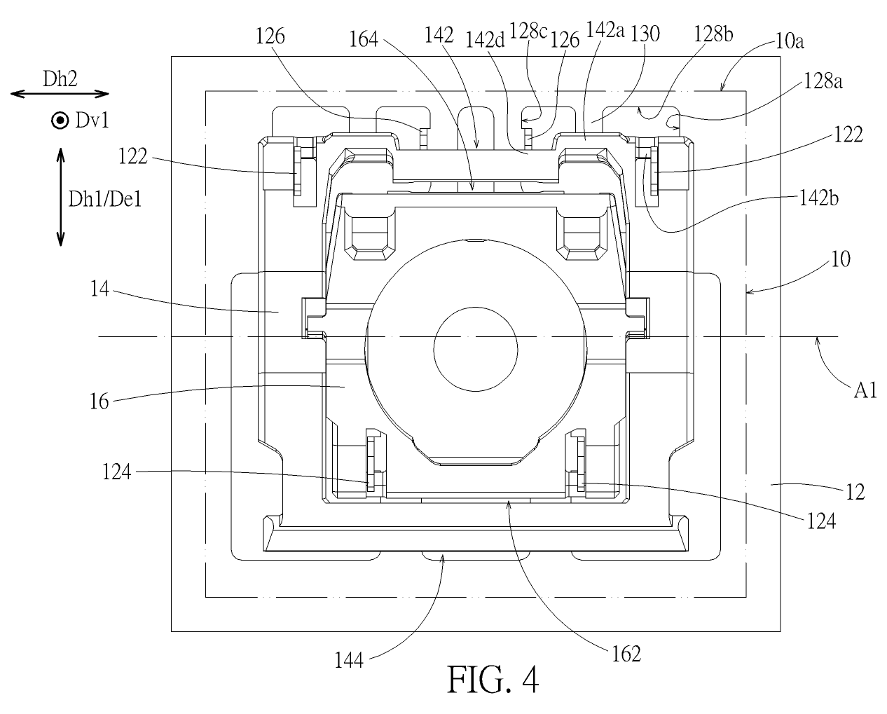

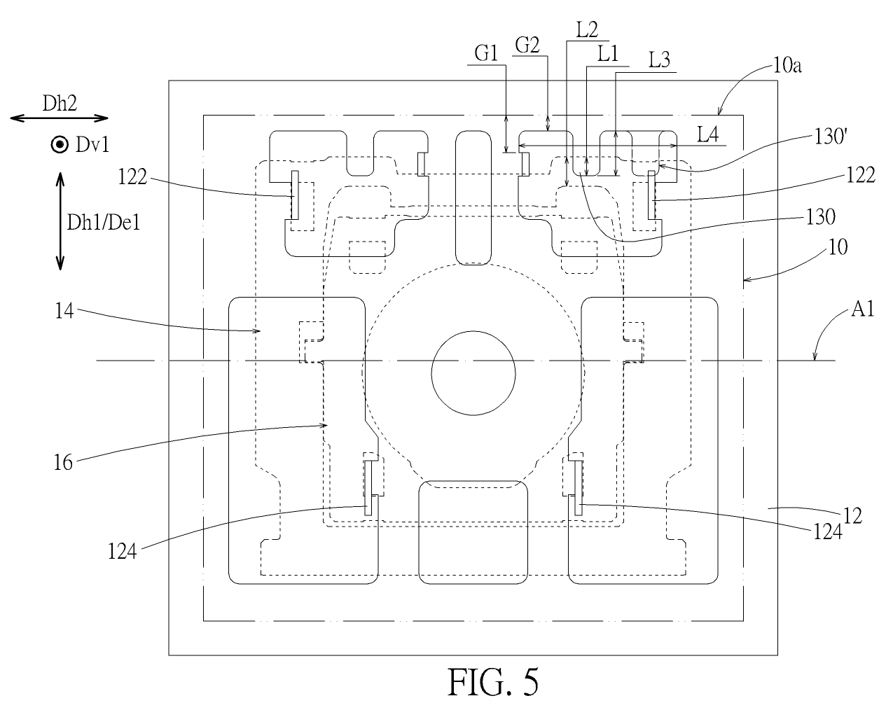

Please refer to FIG. 4 and FIG. 5. Therein, FIG. 4 is a top view of the base plate 12, the first support 14, and the second support 16; the outline of the keycap 10 relative to the base plate 12 is shown in chain lines in the figure. FIG. 5 is a top view of the base plate 12; the outlines of the first support 14 and the second support 16 relative to the base plate 12 are shown in dashed lines in the figure and the outline of the keycap 10 is shown in chain lines in the figure. The tab 130 extends from the outside of the support projection of the first support 14 on the base plate 12 (i.e., equivalent to the outline of the first support 14 shown in FIG. 5) toward the inside of the support projection. The second side 128b of the opening 128 does not overlap with the support projection, so that the part 142a of the base plate connecting end portion 142 (except for the portion corresponding to the tab 130) cannot be directly supported by the base plate 12; however, through the tab 130, the portion 142a can obtain a certain degree of support, which can improve the movement stability of the first support 14 (i.e., rotation relative to the base plate 12). Furthermore, in the horizontal direction Dh1, a length L1 of the overlap between the tab 130 and a projection of the base plate connecting end portion 142 (referring to FIG. 2 and FIG. 3) on the base plate 12 is greater than or equal to 0.5 times a length L2 of a projection of the portion of the base plate connecting end portion 142 corresponding to the tab 130 on the base plate 12. This can enhance the support effect of the tab 130 on the base plate connecting end portion 142. In addition, the length L3 of the tab 130 in the extending direction De1 is less than or equal to 0.5 times the length L4 of the second side 128b of opening 128. This increases the structural strength of the tab 130, which in turn strengthens the support effect of the tab 130 on the base plate connecting end portion 142.

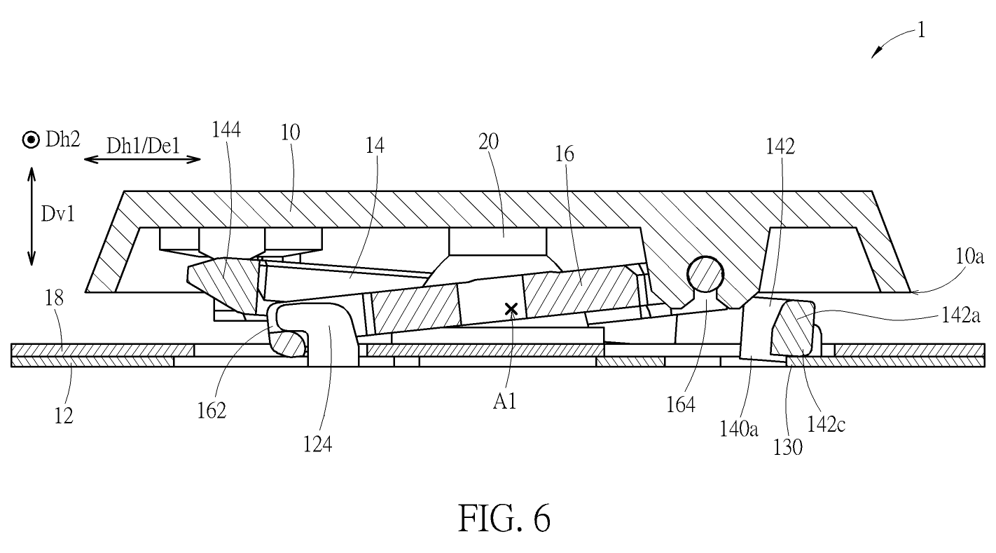

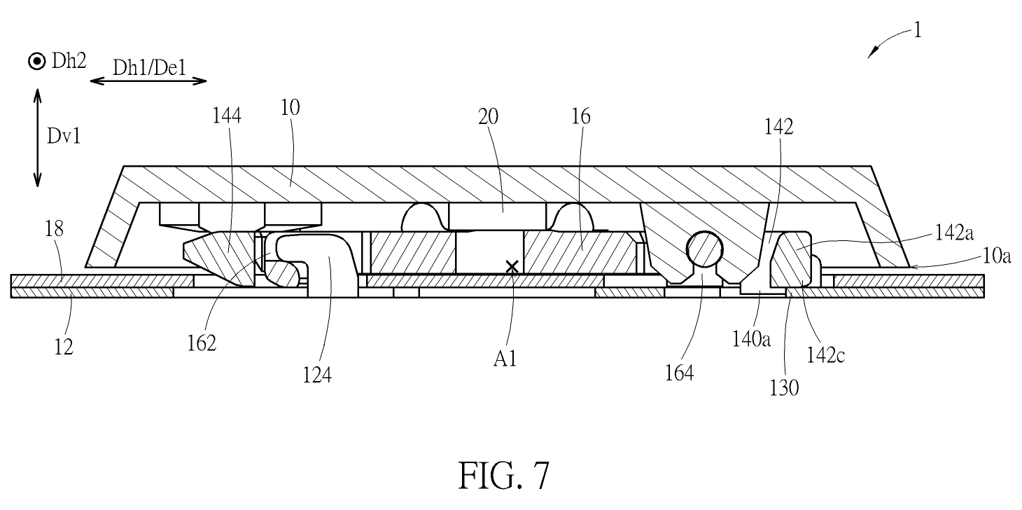

Please refer to FIG. 2, and FIG. 4 to FIG. 7. Therein, the keycap 10 in FIG. 6 is not pressed and is in an unpressed position, and the keycap 10 in FIG. 7 is pressed and is in a pressed position. The keycap 10 moves relative to the base plate 12 along the vertical direction Dv1 through the first support 14 and the second support 16 between the unpressed position (as shown by FIG. 6) and the pressed position (as shown by FIG. 7). When the keycap 10 is in the unpressed position, the base plate connecting end portion 142 abuts against the tab 130 (referring to FIG. 6) and also against the stop portion 126 (referring to FIG. 4). When the keycap 10 is in the pressed position, the base plate connecting end portion 142 abuts against the tab 130 (referring to FIG. 7). Throughout the entire movement of the key switch structure 1 (i.e., during the movement of the keycap 10 between the pressed position and the unpressed position), the projection of the base plate connecting end portion 142 on the base plate 12 overlaps the tab 130 (referring to FIG. 5). In principle, the base plate connecting end portion 142 remains against the tab 130 throughout the entire movement of the key switch structure 1 (i.e., during the movement of the keycap 10 between the pressed position and the unpressed position), which enhances the support effect of the tab 130 on the base plate connecting end portion 142. Furthermore, when the keycap 10 is in the pressed position, the first support 14 partially enters the opening 128, which can increase the structural strength of the first support 14; for example, as shown by FIG. 7, a portion 140a of the first support 14 (located between the tab 130 and the stop portion 126 in the horizontal direction Dh2) enters the opening 128.

In addition, please refer to FIG. 4 and FIG. 5. In the first embodiment, corresponding to the base hook 122, the base plate connecting end portion 142 includes a base shaft 142b. The base shaft 142b is rotatably hooked by the base hook 122. The base shaft 142b and the stop portion 126 overlap in the horizontal direction Dh2. The tab 130 and the stop portion 126 overlap in the horizontal direction Dh2 (referring to FIG. 4 and FIG. 5). The stop portion 126 and the tab 130 are located within the keycap projection of the keycap 10 on the base plate 12 (equivalent to the outline of the keycap 10 shown in FIG. 4 and FIG. 5), so the presence of the tab 130 does not affect the appearance of the key switch structure 1. Furthermore, in the horizontal direction Dh1, a distance G1 between the stop portion 126 and a contour edge of the keycap projection closest to the stop portion 126 is greater than a distance G2 between (the root of) the tab 130 and the contour edge. In addition, in the horizontal direction Dh1, a portion 142c of the base plate connecting end portion 142 that contacts the tab 130 (referring to FIG. 6 and FIG. 7) is closer to an outer edge 10a of the keycap 10 that is closest to the base plate connecting end portion 142 than a portion 142d of the base plate connecting end portion 142 that contacts the stop portion 126 (referring to FIG. 4). In addition, as shown by FIG. 4 and FIG. 5, in the first embodiment, in the horizontal direction Dh2, the tab 130 is located between the base shaft 142b and the stop portion 126. In practice, the location of the tab 130 can be modified to be below the base shaft 142b (as shown by the tab 130' in chain lines in FIG. 5), which allows the base shaft 142b to be directly constrained by the structure (i.e., the base hook 122 and the tab 130) in the vertical direction Dv1, thereby increasing the stability of the base shaft 142b relative to the base plate 12.

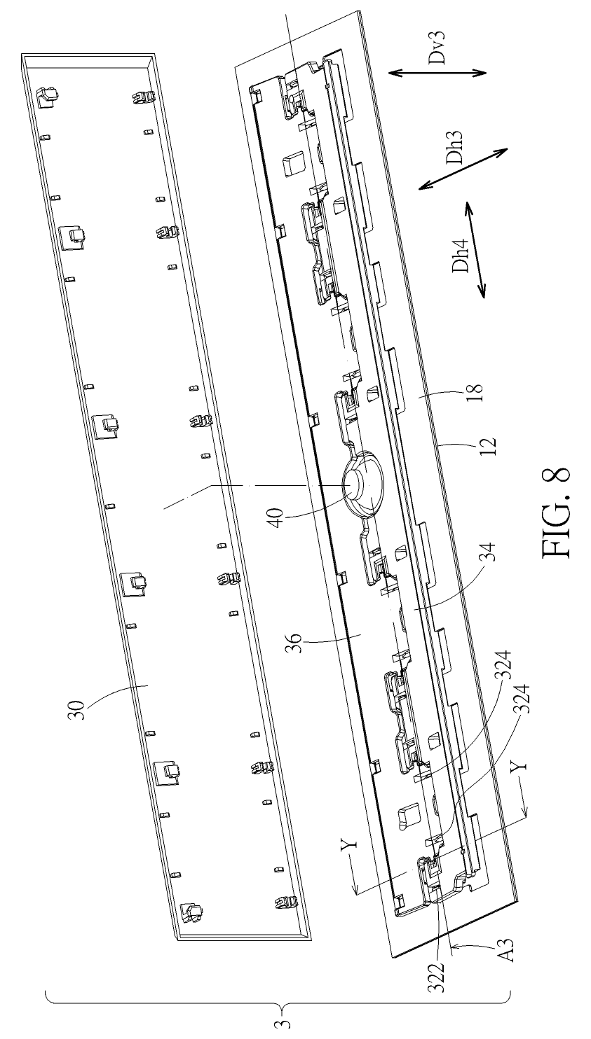

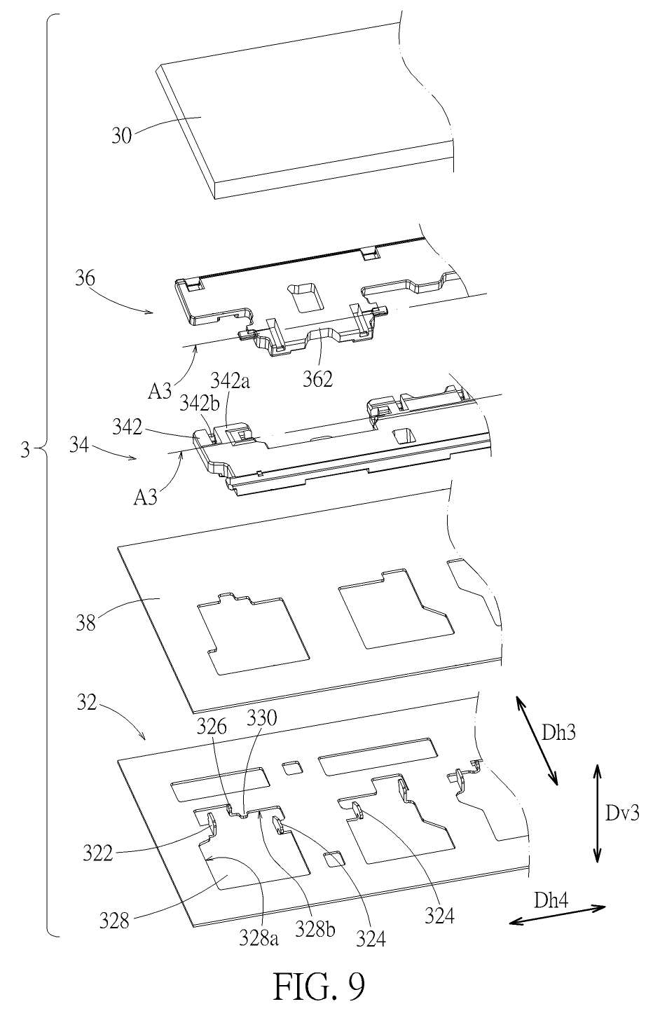

Please refer to FIG. 8 and FIG. 9. A key switch structure 3 according to a second embodiment is a long key, such as, but not limited to, a space key on a keyboard (by modifying its aspect ratio, it can also be a shift key, caps key, control key, back key, etc.). The key switch structure 3 as a whole has a short side direction and a long side direction, which are parallel to a horizontal direction Dh3 and a horizontal direction Dh4, respectively (both are indicated by double-headed arrows in the figures). The key switch structure 3 includes a keycap 30, a base plate 32, a first support 34, a second support 36, a switch circuit board 38, and an elastic dome 40. The keycap 30 is disposed above the base plate 32. The first support 34 and the second support 36 are pivotally connected around a pivot axis A3 (indicated by a chain line in the figures and parallel to the horizontal direction Dh4). The first support 34 and the second support 36 are both connected to and located between the base plate 32 and the keycap 30 to support the keycap 30 above the base plate 32, so that the keycap 30 can move up and down relative to the base plate 32 along a vertical direction Dv3 (indicated by a double-headed arrow in the figures) through the first support 34 and the second support 36. The vertical directions Dv3, the horizontal direction Dh3, and the horizontal direction Dh4 are perpendicular to each other. The switch circuit board 38 is stacked on the base plate 32. The switch circuit board 38 is shown by a single board in the figures to simplify the drawing. The switch circuit board 38 may be, but is not limited to, a membrane circuit board having a switch 382 (indicated by a circle filled with oblique lines in FIG. 9), which roughly corresponds to the center of the keycap 30. The elastic dome 40 is aligned with the switch 382 and disposed on the switch circuit board 38 under the keycap 30.

For more details, in the second embodiment, each of the first support 34 and the second support 36 includes a long arm and a plurality of supporting arms extending from the long arm, and is connected to the keycap 30 through the long arm and connected to the base plate 32 through the plurality of supporting arms. The first support 34 and the second support 36 are also pivotally connected to each other through the supporting arms, and the supporting arms are arranged in an alternating manner. The key switch structure 3 is structurally symmetrical with respect to the horizontal direction Dh3 (roughly from the view point of FIG. 8, it is symmetrical left and right). Taking the left side of the key switch structure 3 in FIG. 8 as an example, the supporting arm of the first support 34 (i.e. the left supporting arm in the figures) includes a base plate connecting end portion 342 and is rotatably connected to a base hook 322 of the base plate 32 through the base plate connecting end portion 342. The supporting arm of the second support 36 (i.e. the left supporting arm in the figures) includes a base plate connecting end portion 362 and is rotatably and slidably connected to base hooks 324 of the base plate 32 through the base plate connecting end portion 362. Furthermore, corresponding to the supporting arm of the first support 34, the base plate 32 also includes a stop portion 326, which is configured to prevent the base plate connecting end portion 342 from detaching from the base hook 322; therein, the base hook 322 and the stop portion 326 are located on opposite sides of the base plate connecting end portion 342 in the horizontal direction Dh3.

Overall, the connection logic of the first support 34 and the second support 36 with the keycap 30 and the base plate 32 is similar to the connection logic of the first support 14 and the second support 16 with the keycap 10 and the base plate 12 in the key switch structure 1 above. Therefore, for other descriptions about the connection of the first support 34 and the second support 36 with the keycap 30 and the base plate 32, please refer to the descriptions of the connection of the first support 14 and the second support 16 with the keycap 10 and the base plate 12 above, which will not be repeated in addition.

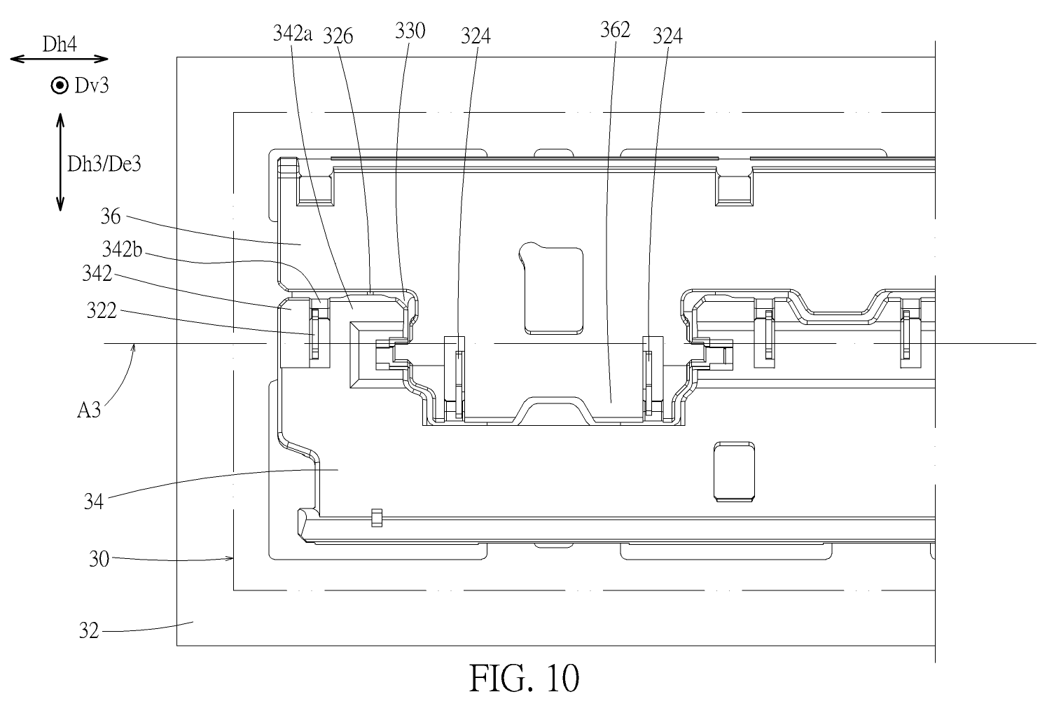

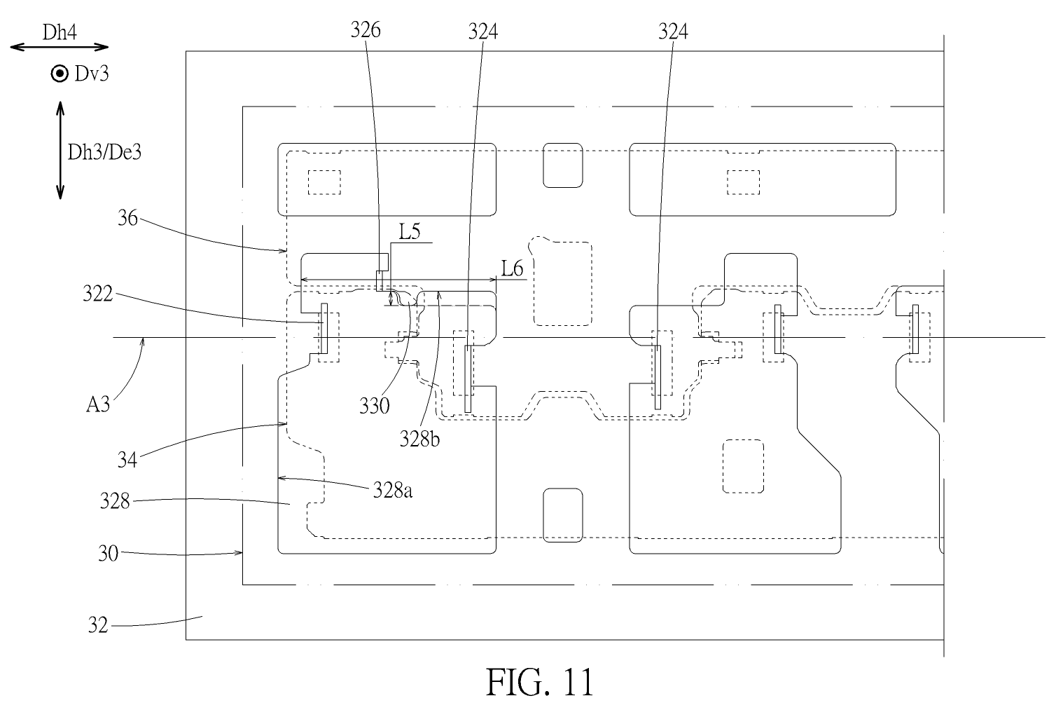

Furthermore, in the second embodiment, as shown by FIG. 9, the base plate 32 has an opening 328. The base hook 322 and the stop portion 326 bend and extend from different sides of the opening 328 (i.e., a first side 328a (left side) and a second side 328b (upper side), respectively). A portion 342a of the base plate connecting end portion 342 of the first support 34, located above the opening 328, is in principle not supported by the base plate 32. However, corresponding to the opening 328, the base plate 32 includes a tab 330 that extends from the second side 328b (i.e., upper side) of the opening 328 along an extending direction De1 (equivalent to the horizontal direction Dh3 and indicated by a double-headed arrow in the figures). In the horizontal direction Dh2, the tab 330 and the base hook 322 are located on opposite sides of the supporting arm of the first support 34. Please also refer to FIG. 10 and FIG. 11. Therein, FIG. 10 is a top view of the base plate 32, the first support 34, and the second support 36 on the left side of the key switch structure 3, in which the outline of the keycap 30 relative to the base plate 32 is shown in chain lines. FIG. 11 is a top view of the base plate 32 on the left side of the key switch structure 3, in which the outlines of the first support 34 and the second support 36 relative to the base plate 32 are shown in dashed lines and the outline of the keycap 30 relative to the base plate 32 is shown in chain lines. The portion 342a of the base plate connecting end portion 342 (roughly located at a corner of the corresponding support arm) is located above the tab 330 (i.e., the tab 330 is located below this portion 342a, so that the tab 330 can provide support for this portion 342a). Furthermore, the length L5 of the tab 330 in the extending direction De3 is less than or equal to 0.5 times the length L6 of the second side 328b of opening 328. This increases the structural strength of the tab 330, which in turn strengthens the support effect of the tab 330 on the base plate connecting end portion 342.

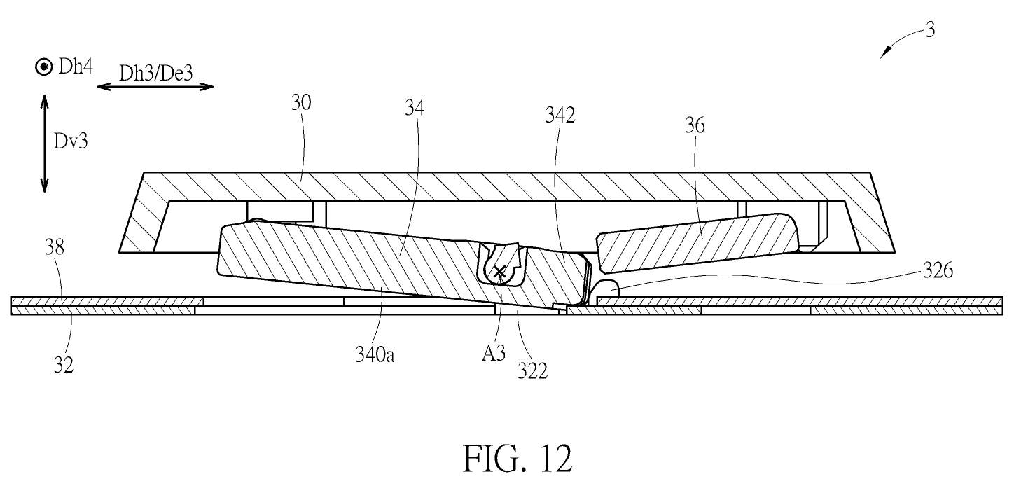

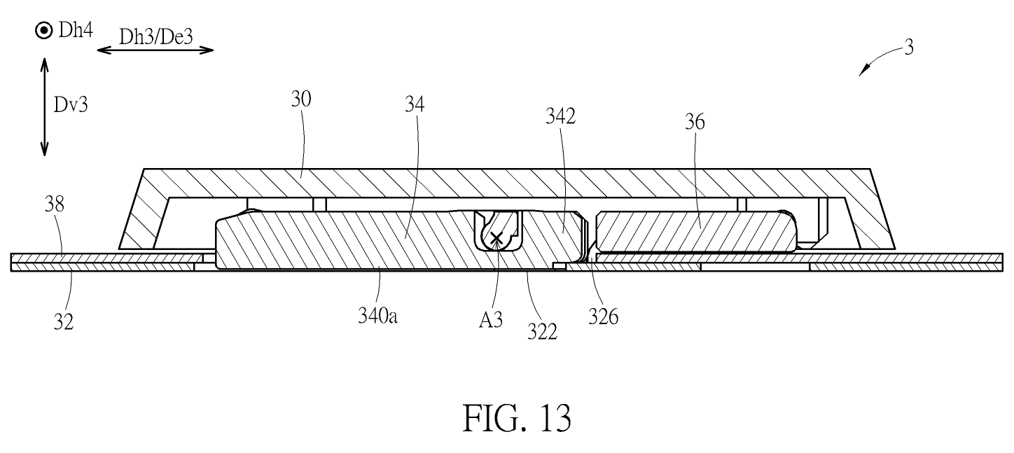

Please also refer to FIG. 12 and FIG. 13. In the second embodiment, the keycap 30 moves relative to the base plate 32 along the vertical direction Dv3 through the first support 34 and the second support 36 between an unpressed position (as shown by FIG. 12) and a pressed position (as shown by FIG. 13). When the keycap 30 is in the unpressed position, the base plate connecting end portion 342 abuts against the tab 330 and also against the stop portion 326 (referring to FIG. 12). When the keycap 30 is in the pressed position, the base plate connecting end portion 342 abuts against the tab 330 (referring to FIG. 13). Throughout the entire movement of the key switch structure 3 (i.e., during the movement of the keycap 30 between the pressed position and the unpressed position), the projection of the base plate connecting end portion 342 on the base plate 32 overlaps the tab 330 (referring to FIG. 11). In principle, the base plate connecting end portion 342 remains against the tab 330 throughout the entire movement of the key switch structure 3 (i.e., during the movement of the keycap 30 between the pressed position and the unpressed position), which enhances the support effect of the tab 330 on the base plate connecting end portion 342. Furthermore, when the keycap 30 is in the pressed position, the first support 34 partially enters the opening 328, which can increase the structural strength of the first support 34; for example, as shown by FIG. 13, a portion 340a of (the supporting arm of) the first support 34 enters the opening 328. In addition, the stop portion 326 and the tab 330 are located within the keycap projection of the keycap 30 on the base plate 32 (equivalent to the outline of the keycap 30 shown in FIG. 10 and FIG. 11), so the presence of the tab 330 does not affect the appearance of the key switch structure 3.

In the key switch structures 1 and 3, both of the tabs 130 and 330 are cantilever structures; it is not limited thereto in practice. For example, the tab 330 can be replaced by a protruding structure facing the opening 328 (shown in chain lines in FIG. 11), which can also provide support for the portion 342a of the base plate connecting end portion 342.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A key switch structure, comprising:
a base plate, the base plate having an opening, a base hook extending from a first side of the opening, and a tab extending from a second side of the opening along an extending direction;
a keycap, the keycap being disposed above the base plate;
a first support, the first support being connected to the base plate and the keycap, the first support comprising a base plate connecting end portion, the base plate connecting end portion being located above the tab and being rotatably connected to the base hook; and
a second support, the second support being connected to the base plate and the keycap, the first support and the second support being pivotally connected around a pivot axis, the pivot axis being not parallel to the extending direction, the keycap moving relative to the base plate along a vertical direction between a pressed position and an unpressed position through the first support and the second support, the vertical direction being perpendicular to the pivot axis and the extending direction;
wherein when the keycap is in the pressed position, the base plate connecting end portion abuts against the tab.

2. The key switch structure according to claim 1, wherein the first support is a rectangular frame support, the second support is pivotally connected to an inner side of the first support, and the tab extends from an outer side of a support projection of the first support on the base plate toward an inner side of the support projection.

3. The key switch structure according to claim 2, wherein the second side of the opening and the support projection do not overlap.

4. The key switch structure according to claim 2, wherein in a direction perpendicular to the pivot axis, a length of an overlap between the tab and a projection of the base plate connecting end portion on the base plate is greater than or equal to 0.5 times a length of a projection of a portion of the base plate connecting end portion corresponding to the tab on the base plate.

5. The key switch structure according to claim 2, wherein the base plate comprises a stop portion, the base hook and the stop portion are located on opposite sides of the base plate connecting end portion in a direction perpendicular to the pivot axis, and the base plate connecting end portion abuts against the stop portion when the keycap is in the unpressed position.

6. The key switch structure according to claim 5, wherein the base plate connecting end portion comprises a base shaft, the base shaft is rotatably hooked by the base hook, and the base shaft and the stop portion overlap in a direction parallel to the pivot axis.

7. The key switch structure according to claim 5, wherein the tab and the stop portion overlap in a direction parallel to the pivot axis.

8. The key switch structure according to claim 5, wherein the stop portion and the tab are located within a keycap projection of the keycap on the base plate, and a distance between the stop portion and a contour edge of the keycap projection closest to the stop portion is greater than a distance between the tab and the contour edge.

9. The key switch structure according to claim 5, wherein in a direction perpendicular to the pivot axis and the vertical direction, a portion of the base plate connecting end portion that contacts the tab is closer to an outer edge of the keycap that is closest to the base plate connecting end portion than a portion of the base plate connecting end portion that contacts the stop portion.

10. The key switch structure according to claim 5, wherein the stop portion extends from a third side of the opening, and in a direction parallel to the pivot axis, the tab is located between the base hook and the stop portion.

11. The key switch structure according to claim 1, wherein a length of the tab in the extending direction is less than or equal to 0.5 times a length of the second side of the opening.

12. The key switch structure according to claim 1, wherein during a movement of the keycap between the pressed position and the unpressed position, a projection of the base plate connecting end portion on the base plate overlap the tab.

13. The key switch structure according to claim 1, wherein the base plate connecting end portion comprises a base shaft, the base shaft is rotatably hooked by the base hook, the base shaft is located above the tab in the vertical direction, and a portion of the first support enters the opening when the keycap is in the pressed position.

14. The key switch structure according to claim 1, wherein when the keycap is in the unpressed position, the base plate connecting end portion abuts against the tab.

15. The key switch structure according to claim 1, wherein in a direction parallel to the pivot axis, the tab is located between the base hook and a center of the keycap.
